(19) United States
(12) Patent Application Publication
(10) Pub. No.: US 2016/0339972 A1
(43) Pub. Date: Nov. 24, 2016

(54) Streamlining stabilizers for the undersides of vehicles

(71) Applicant: William N. Beckon, Davis, CA (US)

(72) Inventor: William N. Beckon, Davis, CA (US)

(21) Appl. No.: 14/717,774

(22) Filed: May 20, 2015

(51) Int. Cl. B62D 37/02; B62D 35/02

(52) U.S. Cl. CPC B62D 37/02; B62D 35/02

(57) ABSTRACT

A system of fairings to streamline the underside of a vehicle, including airfoil-shaped fairings to streamline elements of the vehicle's axle/suspension system. Such fairings may be pivotable and linked to the frame or body of the vehicle in such a way that they adaptively provide down-force or lift, respectively countering the tendency for a wheel to rise off the surface of the road or be squashed against the road due to cross winds or sharp turns. Fairings so configured not only increase efficiency by reducing aerodynamic drag, but also improve vehicle stability, reducing any tendency for the vehicle to overturn.

### FIELD OF THE INVENTION

This invention relates generally to streamlined fairings for wheeled vehicles, including automobiles, trailers, vans, buses, recreational vehicles, trucks, and trains. More particularly, this invention has to do with airfoil-shaped fairings mounted on the undersides of vehicles, and which may be fixed or pivotable to improve the safety and efficiency of such vehicles.

### BACKGROUND OF THE INVENTION

While great advances have been made in streamlining the conspicuous upper parts of automobiles and other vehicles, the aerodynamics of the undersides of vehicles have been relatively neglected. For the most part, the undersides of vehicles have remained lumpy and cluttered with drag-inducing structural elements protruding into the airstream under the vehicle, even though the resulting drag on the vehicle, in reducing fuel efficiency and performance, is no less important than that on the more visible upper side of the vehicle.

Numerous fairings, airfoils, and deflectors have been installed on the upper surfaces of wheeled land vehicles. In many cases these are merely cosmetic imitations of devices originally intended to improve the performance of racing vehicles. For example, patents have been issued related to airfoils known as “spoiler wings”, or simply “spoilers” installed at the rear edge of the upper surface of a passenger vehicle for the purpose of exerting downward force. One such patent, U.S. Pat. No. 7,264,300 issued Sep. 4, 2007 to Hillgaertner disclosed a mechanism for adjusting the height of such an airfoil. U.S. Pat. No. 7,213,870 issued May 8, 2007 to Williams disclosed a mechanism for adjusting both the angle of attack and the extent of surface area of such an airfoil. Generally, such airfoils exert downward force behind the rear wheels of an automobile, levering upwards on the front wheels, thereby degrading the performance, safety, handling and efficiency of the vehicle, especially in modern front-wheel-drive vehicles, which rely on front wheel traction for propulsion as well as steering and braking.

Some inventions have been disclosed for locating fairings and airfoils on the upper surfaces of vehicles for the express purpose of reducing aerodynamic drag. For example, U.S. Pat. No. 4,047,747 issued Sep. 13, 1977 to Beers; U.S. Pat. No. 4,441,753 issued Apr. 10, 1984 to Mason; and U.S. Pat. No. 6,183,041 issued Feb. 6, 2001 to Wilson disclosed adjustable airfoils mounted on the roof of the cab of a tractor-trailer to reduce drag. U.S. Pat. No. 7,226,117 issued Jun. 5, 2007 to Preiss disclosed a “split wing” airfoil at the upper rear edge of a station wagon or hatchback-type vehicle for the purpose of increasing aerodynamic efficiency. U.S. Pat. No. 4,533,168 issued Aug. 6, 1985 to Janssen et al. disclosed a combination of a spoiler and a wing on the upper rear of a passenger vehicle to reduce aerodynamic drag.

U.S. Pat. No. 8,740,285 B2 issued Jun. 3, 2014 to Beckon disclosed an apparatus consisting of one or more airfoils, mounted above the upper surface of a vehicle, which improve the safety and handling of the vehicle as well is increase its efficiency by automatically adjusting to provide either down-thrust or lift depending on the driving situation.

Fairings, skirts, and deflectors have been proposed for the underbodies of semi-trailers with the intention of improving fuel economy by reducing aerodynamic drag. These devices are positioned along the sides of the underbody, in front of the wheels, or behind the wheels, for the purpose of deflecting air flow around the wheels. For example, U.S. Pat. No. 5,280,990 issued Jan. 25, 1994 to Rinard, and U.S. Pat. No. 5,921,617 issued Jul. 13, 1999 to Loewen et al. disclosed adjustable fairings or skirts under the two longitudinal sides of a trailer. U.S. Pat. No. 4,262,953 issued Apr. 21, 1981 to McErlane, U.S. Pat. No. 4,640,542 issued Feb. 3, 1987 to FitzGerald et al., U.S. Pat. No. 7,992,923 B2 issued Aug. 9, 2011 to Dayton, U.S. Pat. No. 8,276,972 B2 issued Oct. 2, 2012 to Domo et al., and U.S. Pat. No. 8,376,450 B1 issued Feb. 19, 2013 to Long et al. disclosed deflectors or fairings under the trailer in front of the rear wheels. U.S. Pat. No. 7,828,368 B2 issued Nov. 9, 2010 to Ortega et al. disclosed a tapered fairing behind the rear wheels of the tractor of a semi-trailer truck to reduce aerodynamic drag.

For pickup trucks and utility vehicles that have high road clearance, U.S. Pat. No. 4,119,339 issued Oct. 10, 1978 to Heimburger disclosed a deflector panel attached below the front end of the vehicle. Although adjustable, this deflector is not under automatic control. When deployed, it increases the projected frontal area of the vehicle, increasing aerodynamic drag on the vehicle. Additionally, it always deflects airflow more or less downward, exerting lift on the front end of the vehicle and therefore reducing front wheel traction.

For automobiles, U.S. Pat. No. 8,366,178 B2 issued Feb. 5, 2013 to Yamagishi et al. disclosed stubby fixed airfoils oriented vertically under the rear of the vehicle to serve as “rectifying fins” intended to stabilize the flow of air under the vehicle. These fins do not streamline existing structures, but rather constitute additional protruding structures, incurring some additional aerodynamic drag.

Devices have been designed for the undersides of automobiles solely for the purpose of providing downward force on the wheels. U.S. Pat. No. 3,618,998 issued Nov. 9, 1971 to Swauger disclosed an automatically adjustable deflector under the front edge of an automobile. This deflector was narrowly designed for rear-engine automobiles such as the Volkswagen “Bug”, to provide down-force at the very front of the vehicle to improve handling by balancing the weight of the engine in the back, and countering the tendency for aerodynamic forces to lift the front of the vehicle at high speeds. U.S. Pat. No. 5,419,608 issued May 30, 1995 to Takemoto disclosed the positioning of fixed airfoils between the front wheels and between the rear wheels of an automobile. These airfoils were not intended to streamline any existing structures of the automobile; therefore they must be regarded as adding some aerodynamic drag to the vehicle. The effect of the devices disclosed by both Swauger and Takemoto is equivalent to adding weight to the vehicle, always more or less pressing downward on the wheels whenever the vehicle is in motion, thus increasing rolling resistance as well as incurring additional aerodynamic drag. Therefore, they improve safety at the cost of decreasing fuel economy. The preferred embodiments of the present invention rectify the limitations of those devices, improving the fuel economy as well as the safety of vehicles by streamlining existing structures and automatically creating downward force only when needed for stability and traction, but automatically creating lift, and thereby reducing rolling resistance and tire wear, whenever such lift safely contributes to vehicle stability and economy.

### SUMMARY OF THE INVENTION

One purpose of the present invention is to reduce aerodynamic drag on the undersides of vehicles, thereby improving their efficiency and economy. Another purpose is to increase the safety of vehicles by stabilizing them so that they are less likely to overturn when experiencing cross winds or when turning sharp corners. To further both of these goals, a system of streamlining fairings under a vehicle optimally includes airfoil-shaped fairings that pivot on axles and other elements of the vehicle's suspension system that protrude more or less horizontally into or across the stream of air below the vehicle.

### BRIEF DESCRIPTION OF THE DRAWINGS

FIG. 1 is a series of three diagrammatic cross sections of an airfoil-shaped fairing (hereinafter denoted simply “airfoil”) on one side of a vehicle adjacent to a wheel, in three situations, illustrating the stabilizing function of the airfoil: (A) the wheel is lightly loaded and the airfoil is in a neutral orientation, exerting no upward or downward force; (B) the vehicle presses down heavily on the wheel causing the airfoil to adjust automatically to provide lift; (C) sideward forces on the vehicle tend to lift the wheel off the surface of the road causing the airfoil to adjust automatically to provide counteracting downward force on the wheel.

FIG. 2 is a detailed cross-section of an airfoil mounted on the axle of a vehicle such as a trailer.

FIG. 3 is a view of the bottom of a trailer from directly below the trailer, with two independently pivoting aerodynamic stabilizers (airfoils) mounted on the two sides of the axle.

FIG. 4 comprises perspective views of sectioned structural elements (other than the axles) of a the suspension system or frame of a vehicle, showing: (A) prior art represented by an I-beam and in inverted U-beam; (B) more streamlined, airfoil-shaped beam; (C) tubular beam on which an airfoil pivots, the preferred embodiment of the current invention applied to such structural elements; (D) prior art beams enclosed in tubular sleeves around which airfoils pivot.

### DRAWING REFERENCE NUMERALS

1 aerodynamic stabilizer (airfoil)
2 vehicle axle
3 bushing
4 spring hanger
5 turnbuckle
6 spring
7 vehicle frame
8 wheel
9 tire
10 road
11 flat fairing

### DETAILED DESCRIPTION

Most vehicles could achieve substantial improvements in aerodynamic efficiency by adding light-weight fairings for the purpose of smoothing the flow of air under the vehicle. Such fairings would be optimized if they were located just beneath the floor of the vehicle and were more or less horizontally flat or slightly curved, and strengthened with shallow creases or corrugations oriented parallel to the direction of movement of the vehicle. However, some elements of the drive train, steering, and suspension systems protrude too far below the floor of the vehicle to be practically covered by such flat fairings. Such protruding elements include cross members; control arms; trailing arms; axle beams, tubes or housings; sway or stabilizer bars; toe links and tie rods. In many vehicles, and especially in trailers, among the most prominent of those elements are the axles. The present invention, in addition to disclosing flat fairings to streamline broad areas of the undersides of vehicles, also discloses airfoil-shaped fairings to streamline protruding elements such as axles. In preferred embodiments of this invention, where practical, these airfoils pivot on the protruding elements, and at least one independently pivoting airfoil is located adjacent to each wheel, so that, in addition to reducing aerodynamic drag on the elements, the airfoils also stabilize the vehicle by adaptively generating downward or upward force on the adjacent wheel, as appropriate to counter any tendency for the wheel to lift off the surface of the roadway or be squashed against the roadway as the vehicle negotiates sharp bends in the road or is buffeted by cross winds. Accordingly, when downward force is not needed for stability, these airfoils are capable of automatically providing lift, reducing rolling resistance and reducing wear on the tires.

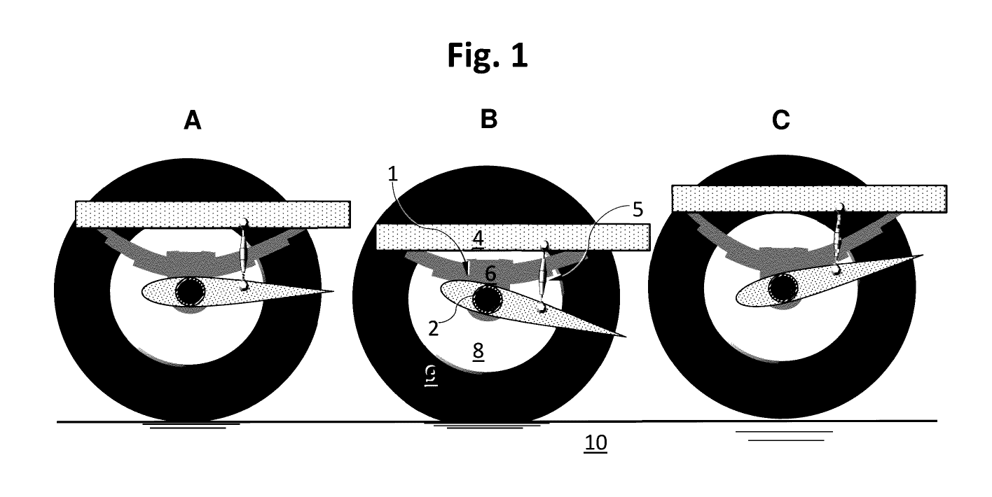

FIG. 1 illustrates the stabilizing action of an airfoil 1 mounted on one side of the axle 2 adjacent to a wheel 8 of a vehicle such as a trailer. The three views are diagrammatic cross sections of the airfoil in three situations: (A) the vehicle is lightly loaded and the airfoil is in a neutral orientation, providing a streamlining effect, but exerting no upward or downward force; (B) the vehicle is heavily loaded or this wheel 8 of the vehicle is pressed down by cross winds or by centrifugal force as the vehicle negotiates a tight curve in the road with this wheel 8 on the outside of the turn; in these circumstances the angle of attack of the airfoil adjusts automatically to provide lift, countering the additional load on the wheel and thereby reducing rolling resistance; (C) this wheel of the vehicle tends to lift off the surface of the road due to cross winds or centrifugal force experienced during a tight turn with this wheel on the inside of the turn; in these circumstances the angle of attack is automatically adjusted to exert force downward, countering the tendency for the vehicle to overturn.

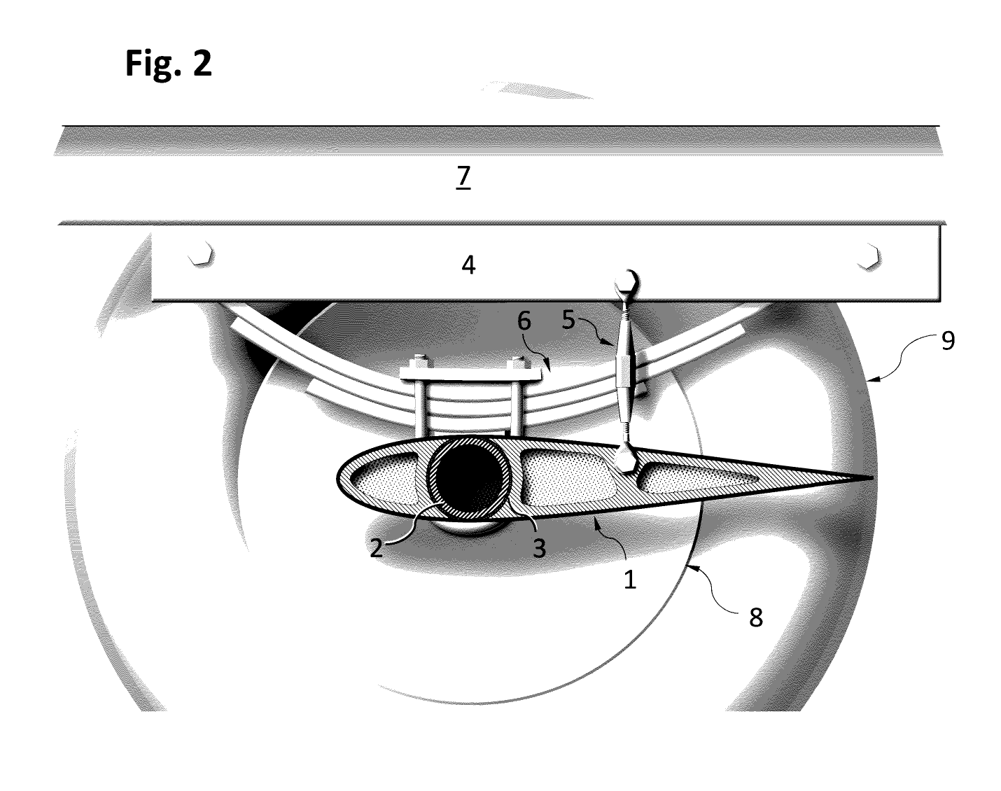

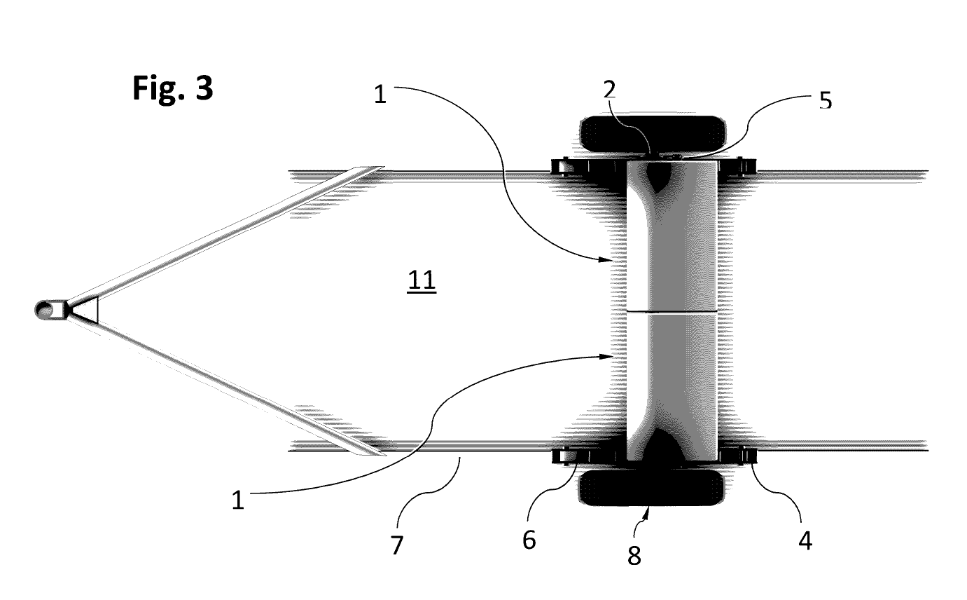

FIG. 2 shows a side view cross section of one airfoil 1 mounted on one side of an axle 2 by means of bushing 3, which minimizes wear and friction as the airfoil pivots around the axle, automatically responding to varying loads on wheel 8. The airfoil is linked to spring hanger 4 by means of turnbuckle 5, providing for automatic adjustment of the angle of attack of the airfoil. For clarity of illustration, the turnbuckle is depicted here in front of spring 6, with the lower end of the turnbuckle connected to the sectioned face of the airfoil; this is a stylistic representation of a more practical and effective embodiment in which the airfoil extends to the outer edge of the spring, and the turnbuckle is attached to the outer edge of the spring hanger 4 and the outer end of the airfoil as shown in FIG. 3 but where it would be largely out of view from the perspective of this figure (looking from under the vehicle outward toward one side of the vehicle).

In the embodiment shown in FIG. 2, the airfoil is largely hollow, to minimize weight. It may be made of a light-weight material such as extruded aluminum.

FIG. 3 shows the underside of a trailer having two airfoils 1 mounted on the two sides of the axle 2. In this view, both airfoils are in the same (neutral) position, as in FIG. 1A, although they independently pivot. A flat fairing 11 covers frame cross members.

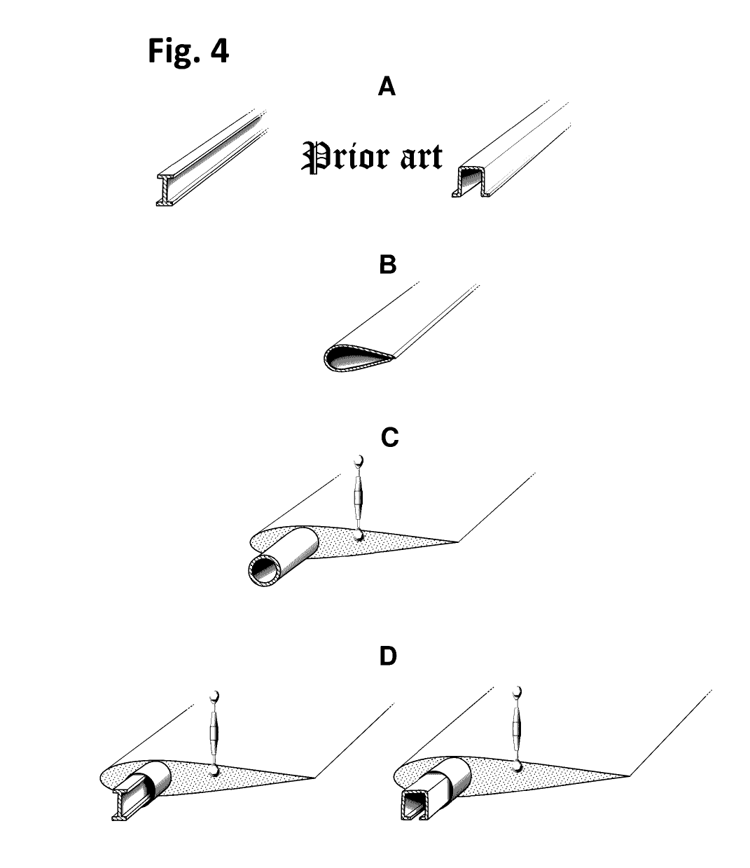

FIG. 4 shows how the present invention may be applied to cross-wise protruding elements of a vehicle's frame or suspension system other than axles and axle tubes. Such elements are commonly not tubular; rather, often they are I-beams or inverted U-beams (A). The aerodynamics of the underside of the vehicle would be markedly improved if these elements were redesigned as rigid airfoil-shaped beams (B). Alternatively, the additional stabilizing advantages of the present invention may be realized if these elements are redesigned as tubular beams around which airfoils pivot (C) or, if design constraints preclude such tubular beams, then the beams of prior art, such as I-beams and U-beams, may be enclosed within cylindrical sleeves around which airfoils pivot (D).

Unlike typical airplane wings, airfoils such as those appropriate for the present invention are designed to produce routinely downward force as well as lift. Therefore, they may have little or no camber, being symmetric or nearly symmetric about the plane passing through the leading and trailing edges, as shown in the above figures. An example of such an airfoil shape is NACA 0012 (Jacobs et al. 1932) used in the wing of the Lockheed C-5 Galaxy aircraft and the rotor blades of helicopters.

To minimize the force required to automatically adjust and maintain the angle of attack, each airfoil preferentially pivots around its aerodynamic center, about ¼ the distance from the leading edge of the airfoil to the trailing edge, approximately as illustrated in the above figures.

Airfoils may be provided with endplates at the lateral ends for the purpose of reducing induced drag caused by wingtip vortices at the lateral ends of the airfoils.

When traveling over bumpy roads, the pivoting airfoils disclosed here have two additional beneficial effects apart from streamlining and stabilizing the vehicle. Because in such conditions, the trailing edges of the airfoils flap up and down continuously, the airfoils effectively provide a sculling effect, somewhat like the propulsive action of an avian wing, transforming into forward propulsion some of the energy that would otherwise be expended in bouncing the vehicle. In doing so, the airfoils dampen some of the bounce, effectively serving as shock absorbers that are more efficient than typical hydraulic shock absorbers, which translate bouncing energy into waste heat rather than propulsion.

Although the figures and description above contain many specific details, these merely provide illustrations and examples of some embodiments of this invention. Various other manifestations, variations, and modifications are possible within its scope. The particular arrangements herein disclosed are meant to be illustrative only and are not to be construed as limiting the scope of the invention, which includes any and all applications, variations, modifications and equivalents within the spirit and scope of the appended claims.

What is claimed is:

1. A system of fairings to streamline the underside of a vehicle.

2. A system of claim 1 in which streamlining is achieved by covering uneven surfaces with a substantially flat, approximately horizontal fairing.

3. A system of claim 2 in which said fairing is provided with shallow corrugations, with ridges oriented parallel to the direction of movement of the vehicle, to strengthen the fairing and smooth the flow of air beneath the vehicle.

4. A system of claim 1 in which structural elements that protrude too far below the vehicle to be practically covered by the fairing of claim 2 are constructed with aerodynamically streamlined shapes.

5. A system of claim 4 in which said streamlining is achieved by aerodynamic fairings mounted on said structural elements.

6. A system of claim 5 in which the said fairings are airfoil-shaped.

7. A system of claim 6 in which protruding structural elements that are approximately horizontal and oriented cross-wise to the direction of travel of the vehicle are cylindrical, with a circular cross-section, so that airfoil-shaped fairings can readily pivot on those elements.

8. A system of claim 6 in which protruding structural elements that are approximately horizontal and oriented cross-wise to the direction of travel of the vehicle but cannot practically be made cylindrical due to design constraints, are instead each enclosed in a cylindrical tube with a circular cross-section, so that airfoil-shaped fairings (airfoils) can readily pivot on those elements.

9. A system of claim 7 or claim 8 in which said airfoils are pivotable around an axis that is approximately horizontal and cross-wise to the direction of travel of the vehicle, thereby being capable of varied angles of attack.

10. A system of claim 9 in which each side of the vehicle is provided with at least one separate and independently pivotable airfoil section, so that the apparatus is capable of simultaneously providing different amounts of down-thrust or lift on the two sides of the vehicle to counteract any tendency of the vehicle to roll.

11. A system of claim 10, in which the airfoils are linked to the frame or other portion of the suspended body of the vehicle, providing for automatic control of the angle of attack of each of the airfoils, automatically accomplishing the stabilizing purpose described in claim 10.

12. A system of claim 11 in which the linkage between each airfoil and the body of the vehicle is adjustable, such as may be achieved by means of a turnbuckle.

13. A system of the configuration of claim 12 in which the cylinder on which the airfoil pivots is provided for the purpose of supporting the airfoil, not necessarily having any other function.
